(19) United States
(12) Patent Application Publication
(10) Pub. No.: US 2006/0267396 A1
(43) Pub. Date: Nov. 30, 2006

(54) Wheel, especially a light metal wheel

(76) Inventor: Heinrich Baumgartner, Schiltach (DE)

Correspondence Address: GREENBERG TRAURIG, LLP, 77 WEST WACKER DRIVE, SUITE 2500, CHICAGO, IL, 60601-1732, US

(21) Appl. No.: 10/543,484

(22) PCT Filed: Dec. 23, 2003
(86) PCT No.: PCT/EP03/14772

§ 371 Date: May 2, 2006

(30) Foreign Application Priority Data
Jan. 27, 2003 (DE) 10302997.4

(51) Int. Cl. B60B 3/06

(52) U.S. Cl. 301/65

(57) ABSTRACT

Disclosed is a wheel, especially a light metal wheel for motor vehicles, essentially comprising a wheel spider (20) and a wheel rim (10). Said wheel rim (10) is provided with an inner rim base (16) and an outer rim base (14) which respectively merge into an inner rim horn (18) and an outer rim horn (12). At least some sections of the outer rim base (14) are made of plastic, said plastic (30) being directly molded onto the wheel (1).

The present invention pertains to a wheel, especially to a light-metal wheel, for motor vehicles according to the introductory clause of Claim 1.

Wheels of this type are extremely popular especially in the light-metal form, because it is possible to obtain technical advantages in addition to an enhancement of the overall aesthetic impression.

In general terms, there is a trend toward reducing the weight of the wheel as much as possible. This is another reason for the increasing use of light-metal wheels. The amount of weight saved in comparison with conventional steel wheels, however, is often not so great after all, because the light-metal alloys used usually do not have the same strength as steel. Such wheels must therefore be designed with thicker walls, as a result of which at least some of the weight advantage is lost.

A wheel with a special design which makes it possible to reduce the weight even further is known from WO 01/17799 A1.

This known wheel has a rim, which is provided with an outer bed and an inner bed. The outer bed in conjunction with a profile segment provides a seat for a tire. A hollow space is present underneath the profile segment, so that a closed, hollow profile is created, which leads to the desired increase in strength. The profile segment consists of separately manufactured half-shells made of plastic, for example, as a result of which a light-weight wheel of high strength especially in the areas which are at particular risk can be constructed.

The disadvantage, however, is that a relatively large amount of technical effort is required to produce this wheel. The profile segment, when designed as a half-shell, must be manufactured separately and then connected to the rim by an adhesive bond or by welds.

The invention is therefore based on the problem of improving a wheel of the type described above in such a way that the manufacturing effort is reduced.

This problem is solved by a wheel with the features of Claim 1.

Advantageous embodiments of the invention are presented by the features of the subclaims.

The invention is based on the idea of molding the plastic directly on the wheel. As a result, it is possible to retain the weight and strength advantages of the known wheel, in which at least a some of the outer bed of the rim is formed by prefabricated profile segments, while the amount of manufacturing work required is significantly reduced at the same time. Through this concept, established production methods such as the injection-molding process can be used.

Special advantages are obtained especially in the case of wheels in which the spider has spokes. The spokes can be provided with hollow spaces to save weight, and these hollow spaces can then be filled with plastic. The plastic core thus obtained is extended radially outward from the immediate vicinity of the spider to the area of the outer bed of the rim, where it can serve directly as a seat for the tire. Thus, although these types of wheels can be manufactured at low cost, superior strength values can also be obtained. In particular, the thickness of the walls of the spokes can be reduced even more, as a result of which a considerable reduction in overall weight can be obtained without causing any loss of strength.

Particular advantages are obtained when foamed plastic is used, which makes it possible to achieve an even further weight reduction. This reduction can amount to at least 1-2 kg per wheel in comparison with previous designs.

It is especially advantageous for the foamed plastic to have a skin on its surface, which thus guarantees smooth, optimal seating for the tire and which in particular also makes it possible to obtain an air-tight joint with the tire without the need for any additional measures.

It is especially easy to obtain a wheel with the required strength properties in a manner which saves weight at the same time by using a reinforced plastic, especially a fiber-reinforced plastic, such as a plastic reinforced with glass fibers or carbon fibers.

Because of their favorable mechanical characteristics, polyamides and polycarbonates in particular are suitable as the plastic in question.

In the following, an exemplary embodiment is explained in greater detail on the basis of the FIGURE.

The FIGURE shows a cross section through half of a wheel according to the invention.

A wheel 1 is built in manner known in and of itself out of a rim 10 and a spider 20.

The rim 10 has an inner bed 16 and an outer bed 14. As these beds extend axially outward, they merge into an inner horn 18 and outer horn 12, respectively. A tire 50 is held between the inner horn 18 and the outer horn 12. The tire is seated on the inner bed 16 and the outer bed 14 and rests laterally against the inner horn 18 and the outer horn 12.

The rim 10 merges into the spider 20, which has a plurality of spokes 22. The spokes 22 are hollow to save weight, each one having a hollow space 24 inside it.

The surface of the plastic foam forms a skin 32 and thus offers a smooth, optimal seat for the tire 50. The strength of the spoke 22 can be increased by filling the hollow space 24 in the spoke 22 with plastic, which is of great advantage especially in the case of light-metal wheels, because this improves their impact behavior. The inventive wheel 1 thus reduces the danger of damage to the tire when it is driven over a curb or a pothole.

1. A wheel, especially a light-metal wheel for motor vehicles, consisting essentially of a spider (20) and a rim (10), where the rim (10) has an inner bed (16) and an outer bed (14), which merge into an inner horn (18) and an outer horn (12), respectively, where at least part of the outer bed (14) is made of plastic, characterized in that the plastic (30) is molded directly on the wheel (1).

2. A wheel according to claim 1, characterized in that the spider (20) has spokes (22) with hollow spaces (24) inside, and in that the hollow spaces in the spokes are filled with plastic (30).

3-6. (canceled)

7. A wheel according to claim 1, characterized in that the plastic (30) is a formed plastic.

8. A wheel according to claim 2, characterized in that the plastic (30) is a formed plastic.

9. A wheel according to claim 7, characterized in that the plastic (30) has a skin (32) on its surface.

10. A wheel according to claim 8, characterized in that the plastic (30) has a skin (32) on its surface.

11. A Wheel according to claim 1, characterized in that the plastic (30) is a reinforced, especially a fiber-reinforced, plastic.

12. A Wheel according to claim 2, characterized in that the plastic (30) is a reinforced, especially a fiber-reinforced, plastic.

13. A Wheel according to claim 7, characterized in that the plastic (30) is a reinforced, especially a fiber-reinforced, plastic.

14. A Wheel according to claim 9, characterized in that the plastic (30) is a reinforced, especially a fiber-reinforced, plastic.

15. A wheel according to claim 1, characterized in that the plastic (30) is a polyamide or a polycarbonate.

16. A wheel according to claim 2, characterized in that the plastic (30) is a polyamide or a polycarbonate.

17. A wheel according to claim 7, characterized in that the plastic (30) is a polyamide or a polycarbonate.

18. A wheel according to claim 9, characterized in that the plastic (30) is a polyamide or a polycarbonate.

19. A wheel according to claim 11, characterized in that the plastic (30) is a polyamide or a polycarbonate.

20. A Wheel according to claim 10, characterized in that the plastic (30) is a reinforced, especially a fiber-reinforced plastic.

21. A wheel according to claim 10, characterized in that the plastic (30) is a polyamide or a polycarbonate.
